(19) United States
(12) Patent Application Publication
(10) Pub. No.: US 2011/0076966 A1
(43) Pub. Date: Mar. 31, 2011

(54) METHOD FOR DRIVING AN ANTENNA OF A MOBILE DEVICE

(75) Inventor: Katsunori Ishimiya, Malmo (SE)

(73) Assignee: SONY ERICSSON MOBILE COMMUNICATIONS AB, Lund (SE)

(21) Appl. No.: 12/568,090

(22) Filed: Sep. 28, 2009

(51) Int. Cl. H04B 1/44

(52) U.S. Cl. 455/78

(57) ABSTRACT

A method for driving an antenna of a mobile device, and a mobile device comprising an antenna, a plurality of antenna matching circuits, a selecting unit and a processing unit are described.

### BACKGROUND OF THE INVENTION

The present invention relates to a method for driving an antenna of a mobile device and a mobile device utilizing the method for driving the antenna of the mobile device.

### BRIEF SUMMARY OF THE INVENTION

According to an embodiment of the present invention, a method for driving an antenna of a mobile device is provided. The mobile device may be for example a mobile phone, a personal digital assistant, a mobile navigation system or a mobile computer with an antenna for transmitting data, for example speech data. According to the method, a plurality of antenna matching circuits for driving the antenna is provided. Furthermore, a plurality of predefined use cases of the mobile device is defined. Each use case defines how the mobile device is arranged relative to a user of the mobile device, which means a manner the mobile device is physically located and oriented in relation to the user of the mobile device. Each use case is associated with one of the plurality of antenna matching circuits. Each of the antenna matching circuits may be adapted to provide an impedance matching between a radio frequency unit of the mobile device and the antenna in the associated use case. Different impedance matchings may be necessary due to a varying impedance of the antenna in response to the different use cases. According to the method a current use case of the mobile device is detected from the plurality of predefined use cases, that means the actual or present arrangement of the mobile device relative to the user of the mobile device is detected. One of the plurality of antenna matching circuits is selected in response to the detected current use case of the mobile device and the antenna is operated with the selected antenna matching circuit.

According to an embodiment, the plurality of use cases comprises at least the following arrangements of the mobile device relative to the user of the mobile device:
A first arrangement, wherein the mobile device is used spaced apart from the user, for example when the mobile device is operated in a hands free operating mode where the user does not touch the mobile device and where the mobile device is for example located on a table or retaining system of a vehicle;
A second arrangement, wherein the mobile device is located in a hand of the user near the head or an ear of the user, and wherein the hand is covering at least partially the antenna;
A third arrangement, wherein the mobile device is held in a hand of the user and near the head of the user, and wherein the hand does not cover the antenna; and
A fourth arrangement, wherein the mobile device is held in the hand of the user and spaced apart from the user, and wherein the hand covers at least a part of the antenna, for example when the user is using a hands free talking function of the mobile device and is holding at the same time the mobile device in his hand.

The current use case can be determined on the basis of for example a proximity sensor of the mobile device. The proximity sensor may be adapted to a sensor if the user is covering the antenna at least partially, and additionally the proximity sensor may be adapted to sense if the mobile device is located near the head of the user. The current use case can be determined also on the basis of a hands free mode setting of the mobile device indicating if the mobile device is operating in a hands free mode or not. Furthermore, the use case can be determined based on a Bluetooth mode setting of the mobile device indicating if a Bluetooth head set is connected to the mobile device. Furthermore, the current use case can be determined on the basis of a detection if a connection to a personal hands free device (PHF device) is established indicating that the mobile device is operated in connection with the personal hands free device, for example in a vehicle. Furthermore, a plurality of proximity sensors can be located on the backside of the mobile device in area of the antenna to determine the current use case.

According to another embodiment, operating the antenna with the selected antenna matching circuit comprises a coupling of the selected antenna matching circuit to the antenna.

Mobile devices with an antenna, especially for example mobile phones, can be operated in a multiplicity of different manners defining different arrangements of the mobile device relative to the user of the mobile device. However, these different arrangements may influence the properties of the antenna of the mobile device, for example an impedance of the antenna. This may lead to a mismatch between a radio frequency unit of the mobile device and the antenna resulting in a degraded performance of the antenna for certain arrangements. This may lead to a drop call or a data communication disconnection and thus a dissatisfaction of the user of the mobile device. By using the above-described method for driving an antenna of a mobile device, an appropriate matching circuit is used to operate the antenna in response to a detected use case or arrangement of the mobile device and thus an improved antenna performance can be achieved for all use cases. Even if the use case or the arrangement is changing during for example a phone call or a data communication, an improved antenna performance can be achieved as the antenna is always operated with the most appropriate antenna matching circuit.

According to an embodiment, a mobile device comprising an antenna, a plurality of antenna matching circuits for driving the antenna, a selecting unit and a processing unit is provided. The selecting unit is adapted to select and couple one of the plurality of antenna matching circuits to the antenna. The processing unit is adapted to detect a current use case of the mobile device from a plurality of predefined use cases of the mobile device. As defined above in connection with the method of the present invention, each use case is associated with one of the plurality of antenna matching circuits and each use case defines an arrangement of the mobile device relative to a user of the mobile device. The processing unit is furthermore adapted to select one of the plurality of antenna matching circuits in response to the detected current use case, and to drive the switching unit to couple the selected antenna matching circuit to the antenna.

The mobile device may comprise a mobile phone, a personal digital assistant, a mobile navigation system or a mobile computer.

Although specific features described in the above summary and in the following detailed description are described in connection with specific embodiments, it is to be understood that the features of the embodiments described can be combined with each other unless it is noted otherwise.

### BRIEF DESCRIPTION OF THE DRAWINGS

Hereinafter, exemplary embodiments of the invention will be described with reference to the drawings.

FIG. 1 shows a diagram wherein a voltage standing wave ratio (VSWR) is plotted against a transmission frequency (f) for three different use cases.

FIG. 2 shows a block diagram of a mobile device according to an embodiment of the present invention.

FIGS. 3a-3c show schematically sensors on a backside of a mobile device according to the present invention in three different use cases.

FIG. 4 shows a table for selecting a matching circuit in response to sensor values of the sensors shown in FIG. 3.

### DETAILED DESCRIPTION OF THE INVENTION

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise. Same reference signs in the various instances of the drawings refer to similar or identical components.

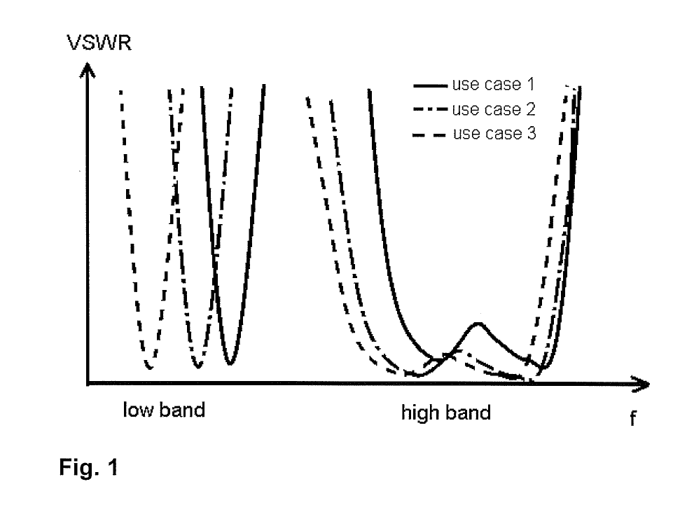

FIG. 1 shows a diagram or plot of a voltage standing wave ratio (VSWR) of a radio frequency unit in combination with an antenna of a mobile device against a transmission frequency (f) for three different use cases.

In use case 1, the mobile device may be operated spaced apart from a user. In case of a mobile phone, the mobile phone may be operated in a hands free operating mode and located apart from the user such that neither the front side nor the rear side of the mobile phone is covered by a body part of the user. The resulting VSWR of this use case is shown in FIG. 1 by the solid line. As can be seen, low values for VSWR indicating a resonance frequency are reached in a low band as well as in a high band. The low band may be for example a transmission band around 900 MHz and the high band may comprise frequencies around 1800 MHz.

In use case 2 the mobile device, for example a mobile phone, may be arranged in a so-called talking position, wherein for example a front side of the mobile phone is arranged near an ear of the user while the mobile phone is held in a hand of the user. However, in this use case 2, the rear side of the mobile phone may not completely be covered by the hand of the user, and therefore especially the antenna part on the rear side of the mobile phone is not or only marginally influenced by the hand of the user. The resulting VSWR of this use case 2 is shown in FIG. 1 by the dot and dash line.

In use case 3, the mobile device, for example a mobile phone, may also be arranged in a talking position with the front side of the mobile phone facing an ear of the user as in use case 2, but in use case 3, the hand of the user additionally covers an area on the rear side of the mobile phone where the antenna of the mobile phone is located. Thus the antenna is not only influenced by the head and ear of the user, but additionally by the hand of the user. The resulting VSWR of this arrangement of use case 3 is shown by the dashed line in FIG. 1.

As can be seen from the graphs for the three use cases in FIG. 1, the minimum of the VSWR, i.e. the resonance frequency, at both low band and high band are shifted in response to the use cases. If for example the antenna and the corresponding radio frequency unit of the mobile device are matched to one use case, for example, are matched to one use case 2, then there is a mismatch for the other use cases, i.e. use case 1 and use case 3. This may result in a degraded transmission and therefore the possibility of a drop call or a disconnect during talking is increased.

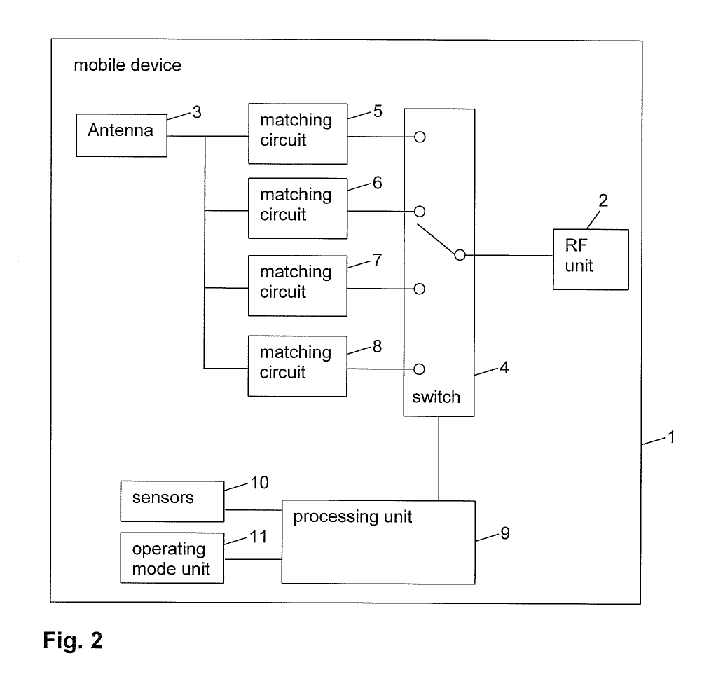

FIG. 2 shows a mobile device according to an embodiment of the present invention. The mobile device 1 comprises a radio frequency unit (RF unit) 2 coupled to an antenna 3 of the mobile device. For coupling the radio frequency unit 2 to the antenna 3, a switch 4 is provided in the mobile device 1 which couples selectively the radio frequency unit 2 with one of a plurality of matching circuits 5-8 of the mobile device 1. Another end of the matching circuits 5-8 is coupled to the antenna 3. A processing unit 9 is coupled to the switch 4 for controlling a switching of the switch 4 and thus for connecting the radio frequency unit 2 to one of the matching circuits 5-8. The processing unit 9 is furthermore connected to sensors 10 of the mobile device 1 and an operating mode unit 11 of the mobile device 1. The sensors 10 may be for example proximity sensors for detecting if the front side and/or the rear side of the mobile device is located near a body part of a user of the mobile device. The operating mode unit may be adapted to provide an information about a current operating mode of the mobile device, for example if a head set, for example a Bluetooth headset, is connected to the mobile device, if a hands free mode of the mobile device is activated, or if the mobile device is connected to a personal hands free equipment (PHF) of, for example, a vehicle.

Each of the matching circuits 5-8 provides a different matching characteristic for matching the radio frequency unit 2 to the antenna 3.

Matching circuit 5 may be for example adapted to provide an optimum matching between the radio frequency unit 2 and the antenna 3 for the case that the antenna 3 is located in a free space, that is to say that around the antenna no body part of a user is located at close range. This may be the case when the mobile device is used in a hands free mode.

Matching circuits 6 may be adapted to provide an optimum matching between the antenna 3 and the radio frequency unit 2 when a front side of the antenna is located near a body part of the user, for example an ear of the user, and a rear part of the antenna is located near another body part of the user, for example one or more fingers of the user. This may be the case when the mobile device is used in a talking position with the mobile device being arranged near the ear of the user and a hand of the user being arranged on the rear side of the mobile device.

Matching circuit 7 may be adapted to provide an optimum matching between the radio frequency unit 2 and the antenna 3 in a case where only the rear side of the antenna 3 is covered by a body part of the user, for example when the user is holding the mobile device in his hand and composing an email or a message to be transmitted via a short messaging service (SMS), wherein a front side of the mobile device is not in the proximity of a body part.

Finally, matching circuit 8 may be adapted to provide an optimum matching between the radio frequency unit 2 and the antenna 3 for a case that the front side of the mobile device and thus the front side of the antenna is located near an ear of the user, but the rear side of the mobile device, especially the rear side of the antenna, is not covered by any body part. This may be the case when the user is using the mobile device in a talking position holding the mobile device near his ear, and holding the mobile device with the fingers such that the rear side of the mobile device is not completely covered by the fingers.

The processing unit 9 receives information about a current operating mode of the mobile device 1 from the operating mode unit 11 and furthermore information from the proximity sensors 10. The proximity sensors 10 may be located on the front side and on the rear side of the mobile device in an area of the antenna 3 to provide information if a body part of the user of the mobile device is covering a front and/or a rear side of the antenna 3. Furthermore, there may be more than one proximity sensor on each side of the antenna to provide an information if the antenna 3 is partly or completely covered by a body part of the user. From this information derived from sensors 10 and the operating mode unit 11, the processing unit 9 determines a current use case of the mobile device 1 and controls the switch 4 according to the detected use case to connect the radio frequency unit 2 via the switch 4 to an appropriate matching circuit 5-8 and to the antenna 3. When, for example, the operating mode unit 11 indicates that the user is composing an email or an SMS and currently no talking connection is established, the processing unit 9 may control the switch 4 such that the connection between the radio frequency unit 2 and the antenna 3 is established via matching circuit 7.

When, for example, a proximity sensor above a display of the mobile device 1 indicates the proximity of a body part, and another proximity sensor on the rear side of the mobile device indicates also the proximity of a body part, the processing unit 9 determines from this a use case where the mobile device is held in a hand near the head of the user and the hand covers the antenna at least partially. Accordingly, the processing unit 9 drives the switch 4 such that matching circuit 6 is used in the coupling of radio frequency unit 2 to the antenna 3.

According to another example, the processing unit 9 may drive the switch 4 such that matching circuit 8 is used for coupling the radio frequency unit 2 to the antenna 3, when a proximity sensor on the front side of the mobile device indicates a proximity to a body part, and the operating mode unit 11 indicates that a hands free mode is off, a Bluetooth mode is off, and a personal hands free mode (PHF) is also off.

Although in the above-described embodiment four matching circuits 5-8 are provided, any other number of matching circuits may be provided, for example two, three, five or even more, if appropriate.

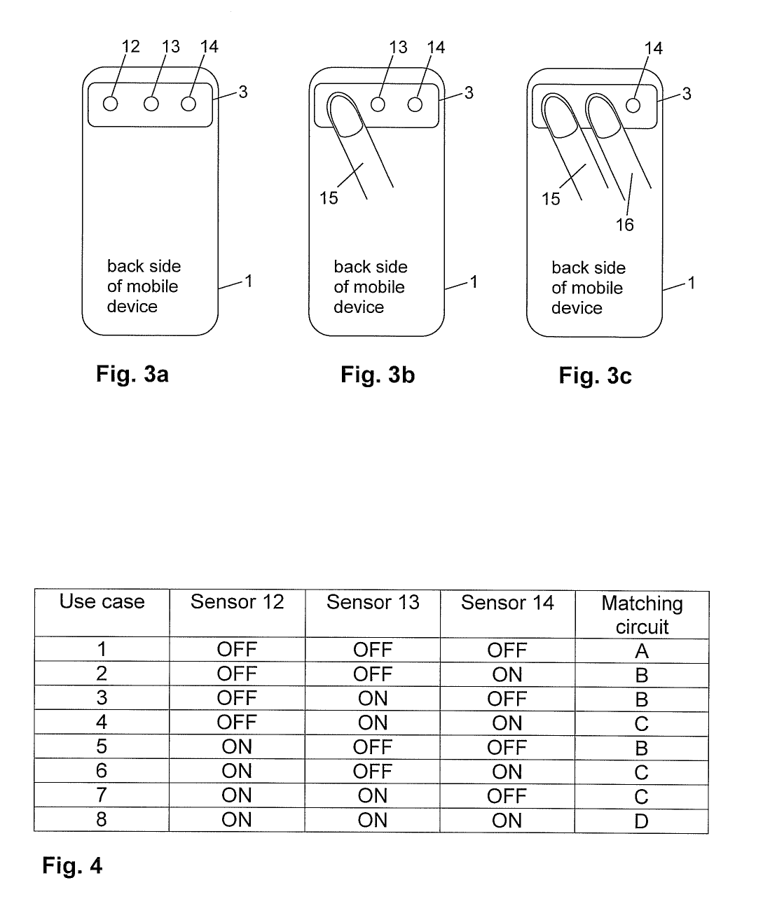

FIG. 3a shows a backside of another embodiment of a mobile device, for example a mobile phone 1, comprising an antenna 3 located on an upper side of the mobile device 1, and three proximity sensors 12-14 located in three different areas of the antenna 3. In FIG. 3a the proximity sensors 12-14 are not covered by any body part of a user, whereas in FIG. 3b sensor 12 is covered by a first finger 15 of the user and whereas in FIG. 3c sensors 12 and 13 are covered by the first finger 15 and a second finger 16, respectively, of the user.

Depending on the coverage of the sensors 12-14, eight use cases can be defined as shown in the table of FIG. 4. When one of the sensors 12-14 does not detect a proximity to a body part of the user, this is indicated by “OFF” in the table of FIG. 4, and if one of the sensors 12-14 detects a proximity to a body part, this is indicated by an “ON” in the table of FIG. 4. However, although in the example of FIG. 4 eight use cases are defined, some of the use cases may share a common matching circuit to provide an optimum matching of the antenna 3 to the radio frequency unit of the mobile device 1. In an exemplary embodiment four different matching circuits A-D may be provided, which provide an optimum matching depending on the amount of area which is covered by body parts of the user. Matching circuit A may be selected, if the area or antenna 3 is completely uncovered, matching circuit B may be selected, if one third of the area of the antenna is covered by a body part, matching circuit C may be selected if two thirds of the area of the antenna 3 are covered, and matching circuit D may be selected if the whole area of the antenna 3 is covered by body parts of the user. A corresponding assignment of the use cases to the matching circuits to be used is shown in the table of FIG. 4. As can be seen, the number of matching circuits may be lower than the number of use cases defined.

Although the antenna 3 is located on an upper side of the mobile device 1 in FIGS. 3a-3c, the antenna 3 and the sensors 12-14 may be located at any other appropriate location of the mobile device 1, e.g. on a lower side or a bottom side of the mobile device 1.

While exemplary embodiments have been described above, various modifications may be implemented in other embodiments. For example, the use cases defined in connection with FIG. 2 may be combined with the use cases defined in connection with FIGS. 3 and 4 whereby also the number of matching circuits may be increased. However, some matching circuits may be shared by several use cases, which reduces the number of required matching circuits. Furthermore, instead of providing dedicated matching circuits which are selected by switch 4, one or more configurable matching circuits may be provided which may be configurable via a control from the processing unit 9.

Additionally, instead of or additional to the proximity sensor any other kind of sensor may be used if appropriate, e.g. a touch sensor or a thermo sensor.

Finally, it is to be understood that all the embodiments described above are considered to be comprised by the present invention as it is defined by the appended claims.

What is claimed is:

1. A method for driving an antenna of a mobile device, the method comprising:
providing a plurality of antenna matching circuits for driving the antenna,
providing a plurality of predefined use cases of the mobile device, wherein each use case is associated with one of the plurality of antenna matching circuits, wherein a use case defines an arrangement the mobile device is arranged relative to a user of the mobile device,
detecting a current use case of the mobile device from the plurality of predefined use cases,
selecting one of the plurality of antenna matching circuits in response to the detected current use case of the mobile device, and
operating the antenna with the selected antenna matching circuit.

2. The method according to claim 1, wherein the plurality use cases comprise
a first arrangement, wherein the mobile device is used spaced apart from the user,
a second arrangement, wherein the mobile device is used when being held in a hand and near the head of the user, the hand covering at least part of the antenna,
a third arrangement, wherein the mobile device is used when being held in the hand and near the head of the user, the hand not covering the antenna, and
a forth arrangement, wherein the mobile device is used when being held in the hand and spaced apart from the head of the user, the hand covering at least part of the antenna.

3. The method according to claim 1, wherein the current use case is determined based on at least one of the following:
a sensor of the mobile device,
a hands free mode setting of the mobile device,
a Bluetooth mode setting of the mobile device, and
a detection of a connection to a personal hands free device.

4. The method according to claim 1, wherein the current use case is determined based on a plurality of proximity sensors located on a back side of the mobile device in an area of the antenna.

5. The method according to claim 1, wherein the step of operating the antenna with the selected antenna matching circuit comprises coupling the selected antenna matching circuit to the antenna.

6. A mobile device comprising:
an antenna,
a plurality of antenna matching circuits for driving the antenna,
a selecting unit for selecting and coupling one of the plurality of antenna matching circuits to the antenna,
a processing unit adapted to detect a current use case of the mobile device from a plurality of predefined use cases of the mobile device, wherein each use case is associated with one of the plurality of antenna matching circuits, wherein a use case defines an arrangement the mobile device is arranged relative to a user of the mobile device,
the processing unit being further adapted to select one of the plurality of antenna matching circuits in response to the detected current use case, and to drive the switching unit to couple the selected antenna matching circuit to the antenna.

7. The mobile device according to claim 6, wherein the mobile device comprises a device selected from the group comprising a mobile phone, a personal digital assistant, a mobile navigation system, and a mobile computer.
